(19) United States
(12) Patent Application Publication
(10) Pub. No.: US 2018/0144354 A1
(43) Pub. Date: May 24, 2018

(54) NEAR FIELD COMMUNICATIONS BASED OPINION COLLECTION CONTENT CREATION SYSTEM

(71) Applicant: Jesus Acosta-Cazaubon, Rochester, NY (US)

(72) Inventor: Jesus Acosta-Cazaubon, Rochester, NY (US)

(21) Appl. No.: 15/860,604

(22) Filed: Jan. 2, 2018

Related U.S. Application Data
(63) Continuation-in-part of application No. 14/345,693, filed on Mar. 19, 2014.

(51) Int. Cl. G06Q 30/02; G06K 7/10; H04B 5/00

(52) U.S. Cl. CPC G06Q 30/0203; H04B 5/0062; G06K 7/10297; G06K 7/10425

(57) ABSTRACT

A Near Field Communications (NFC) opinion expression system comprising a pair of NFC tags, each of the pair of tags is configured to emit a signal corresponding to an answer, an NFC reader configured to receive a signal from the pair of NFC tags, a display, a server adapted to store a plurality of opinion collection contents and their corresponding statistics and an application configured for retrieving an opinion collection content from the server, displaying the opinion collection content on the display, wherein the application is configured to associate a signal received from the pair of NFC tags to the opinion collection content and update the statistics of the opinion collection content in the server.

### PRIORITY CLAIM AND RELATED APPLICATIONS

This application claims the benefit of priority from provisional applications U.S. Ser. No. 61/606,539 filed Mar. 5, 2012, U.S. Ser. No. 61/655,537 filed Jun. 5, 2012, U.S. Ser. No. 61/700,752 filed Sep. 13, 2012 and PCT/US2013/027890, a PCT application filed Feb. 27, 2013 and a national stage application U.S. Ser. No. 14/345,693 filed Mar. 19, 2014. Each of said applications is incorporated by reference in its entirety.

### BACKGROUND OF THE INVENTION

### 1. The Field of the Invention

The present invention is directed generally to a system for conducting a Radio Frequency Identification (RFID) opinion collection system. More specifically, the present invention is directed to a system for conducting opinion collections using Near Field Communications (NFC) technology.

### 2. Background Art

Various efforts have been made to increase the rate at which opinion collection data is collected. There are several major factors affecting opinion collection data collection: (1) The ease with which an opinion collection is presented and to which it can be responded. The easier it is for an opinion collection content to be presented to a user and for the user to respond to the opinion collection content, the more likely it is for the user to respond to the opinion collection content; (2) The expectation of a user that his or her response to the opinion collection content will create significant impact to the opinion collection result; and (3) The expectation of a user for a reward if the user responded to the opinion collection content. The following patent disclosures demonstrate some uses of NFC. However, none of disclosures demonstrates the use of NFC to conduct opinion collections.

NFC is a very short range contactless data transfer technology related to RFID. NFC has experienced increasingly widespread uses in a variety of applications such as point-of-sale purchases and product inventorying using mobile devices with NFC built-in NFC interfaces. Another NFC application that has been proposed and deployed is to store Universal Resource Identifiers (URI) in NFC tags attached to various products. Users with NFC-equipped mobile devices can scan the NFC tag on a product to automatically call up web content associated with the product on their mobile devices. This eliminates the need to manually enter a URI on a device with limited keypad usability. What are not considered are: (1) the use of NFC as an answer to an opinion collection content; (2) the use of NFC to retrieve collected opinions; and (3) the use of NFC on washable materials to retrieve collected opinions.

U.S. Pat. Pub. No. 20080162141 to Lortz discloses a method for combining speech recognition with NFC to enable a user to enter, store, and use web addresses on portable devices. A user of a portable device having a NFC reader, a voice input interface, a speech recognition system, and memory enables the NFC reader of the portable device to touch an NFC tag or reader found on an object. The object contains information of interest to a user of the portable device. When the NFC reader and the NFC tag or reader touch, the portable device receives a URI and default keywords associated with the URI. The portable device stores the URI in a persistent storage of the portable device based on the default keywords, and date, time, and location of when and where the URI was obtained. The user of the portable device can then retrieve and use the URI at a later time using the voice input interface and the speech recognition system. The user speaks the default keywords into the voice input interface and the speech recognition system, and the speech recognition system to retrieves the URI.

Similarly, Quick Response (QR) code has also seen widespread uses ranging from product and event labeling to storing Universal Resource Identifiers (URI) to solve similar problems of accessing web content using limited keypad usability. There are several drawbacks associated with using QR codes for purposes of expressing opinion. A QR code involves using a camera to first capture an image of the QR code and then using a QR code reader to decipher the QR code. The two step process can cause significant delays especially when the QR code is not appropriately lit. Dimly lit QR codes can be impossible to capture as a sharp image with sufficient resolution is required. Further, it may be impractical to provide QR codes in obscure places such as the bottom of a shoe which is designed to come in rubbing contact with floors or grounds.

Given the foregoing, what is needed is a system which facilitates opinion expression with RFID or more specifically NFC which reduces the number of steps required to express an opinion, thereby promoting participation in opinion collections.

### SUMMARY OF THE INVENTION

The present invention meets the above-identified needs by providing a Near Field Communications (NFC) opinion expression system adapted to serve an opinion collection content regarding an item to a user and ensure the user is in close proximity to the item, the system including:
(a) an NFC device configured to emit a signal corresponding to a first designator, wherein the first designator corresponds to the item;
(b) a second designator corresponding to a location, the second designator provided by a data selected from the group consisting of Domain Name Systems (DNS) and Global Positioning System (GPS);
(c) a server adapted to store a plurality of location-based opinion collection contents;
(d) a mobile device configured for obtaining said first designator and said second designator; and
(e) an opinion collection content creator including a means for retrieving at least one location-based opinion collection content corresponding to the first and second designators from the server, wherein the means for retrieving at least one opinion collection content is selected from the group consisting of retrieving one or more relevant readily available opinion collection contents that match the item at the location, from a specific Universal Resource Identifier (URI) corresponding to the server and creating one or more new location-based opinion collection contents that relate to the item at the location, the one or more new location-based opinion collection contents are configured to be stored in the server such that the first designator indicates only the item and without association to the location, thereby enabling the use of a generically-programmed inexpensive NFC device for the creation of a location-based opinion collection content.

Accordingly, it is a primary object of the present invention to provide an opinion expression system which reduces the number of steps required to access and respond to an opinion collection content such that participation in the opinion collection is encouraged.

It is another object of the present invention to provide an opinion expression system which requires few or inexpensive tools from a user to express an opinion while providing easily accessible opinion collection contents.

It is another object of the present invention to provide an opinion expression system that can be used in public areas while concealing users' opinions from spectators.

It is another object of the present invention to provide an opinion expression system that does not require NFC tags to be specifically programmed, thereby enabling the use of generically-programmed NFC tags.

It is another object of the present invention to allow a user to aggregate opinion collection contents before the user is required to respond to one or more aggregated opinion collection contents.

It is another object of the present invention to enable the creation of opinion collection content families where multiple related opinion collection contents within each such family are linked and their statistics preserved and where the answer choices of such families may be collected and presented to users as collections of choices more specifically targeted to the categories to which the opinion collection content families belong.

It is another object of the present invention to provide a media having different opinion collection contents associated with the media at different time frames such that suitable opinion collection contents may be presented to a user of the media within a specific time frame.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts one embodiment according to the present NFC based opinion expression system.

FIG. 2 is a bottom orthogonal view of a pair of shoes, each of the pair of shoes having an NFC affixed to its sole.

FIG. 2A is a top orthogonal view of another embodiment of the present display.

FIG. 2B is a top orthogonal view of a display having an embedded NFC reader.

FIG. 3 is a block diagram of the embodiment of FIG. 1.

FIG. 4 depicts another embodiment according to the present NFC based opinion expression system.

FIG. 5 is a block diagram of the embodiment of FIG. 4.

FIG. 6 is a flow diagram describing an exemplary method for receiving and tallying an answer stored on an NFC tag according to one embodiment of the present invention.

FIG. 7 is another example of an object where the present invention can be suitably applied.

FIG. 8 depicts yet another embodiment according to the present NFC based opinion expression system.

FIG. 8A depicts an interaction area through which an opinion collection content can be created.

FIG. 8B depicts an interaction area through which an opinion collection content can be created and where the interaction area is located in a mobile device having detected an NFC tag that has a different identifier than the NFC tag of FIG. 8A.

FIG. 8C depicts an interaction area through which an opinion collection content is created and where the interaction area is located in a mobile device having detected an NFC tag that has an identifier that is identical to the NFC tag of FIG. 8A.

FIG. 9 is a block diagram of the embodiment of FIG. 8.

FIG. 10 is a flow diagram describing an exemplary method for retrieving and using a URI stored on an NFC tag according to an embodiment of the present invention.

FIG. 11 is yet another example of an object where the present invention can be suitably applied.

FIG. 12 depicts yet another embodiment according to the present NFC based opinion expression.

FIG. 13 is a flow diagram describing an exemplary method of the present invention for conducting an opinion collection by incorporating more than one NFC tag.

FIG. 14 is yet another embodiment according to the present NFC based opinion expression depicting the use of three possible NFC communication points.

FIG. 15 is yet another embodiment according to the present NFC based opinion expression, depicting the use of an additional designator in combination with an NFC to more specifically define a URI.

FIG. 16 is yet another embodiment according to the present NFC based opinion expression, depicting the use of yet another additional designator in combination with an NFC to more specifically define a URI.

FIG. 17 depicts a series of steps, which when repeated, can be used to build a hierarchy of items.

FIG. 18 depicts a hierarchy of items built by submissions of NFC tag detections.

FIG. 19 depicts a seed opinion collection.

FIG. 20 depicts an opinion collection content family created based on the seed opinion collection of FIG. 19.

FIG. 21 depicts an aggregate of answers collected from the opinion collection content family of FIG. 20.

FIG. 22 is a block diagram depicting an aggregation of items at a location.

FIG. 23 is a block diagram depicting aggregated items at a location and an opinion collection associated with each of the items.

FIG. 24 is a diagram depicting a video-type survey construction and survey taking interface at a first time stamp.

FIG. 25 is a diagram depicting a video-type survey construction and survey taking interface at a second time stamp that is different time from the time stamp shown in FIG. 24.

### PARTS LIST

2—Near Field Communication (NFC) reader

4—transmitter for relaying received signal from NFC tag

6—controller

8—display

10—display stand

12—floor

14—NFC tag

16—footwear

17—shoe sole

18—user

20—table

22—protective case

24—mobile device

26—receiver

28—central processing unit (CPU)

30—internet

32—opinion collection content pool server

34—touchscreen input receiver

36—website

38—NFC tag

40—shirt

42—sleeve

43—cuff

44—step of presenting opinion collection content to display

46—step of detecting NFC tag by NFC reader

48—step of deciphering signal associated with NFC tag

50—step of associating result to opinion collection content

52—step of notifying opinion collection content pool server

54—indicator

56—step of touching NFC tag upon NFC reader

58—step of receiving Universal Resource Identifiers (URI) from an NFC tag

60—step of retrieving resources associated with the Universal Resource Identifiers (URI) and displaying the website associated with the URI on mobile device

62—step of providing answers to opinion collection content

64—opinion collection content

66—entry location of a venue or locale

68—exit location of a venue or locale

70—entry location NFC

72—exit location NFC

74—step of marking the starting point of data collection at website on mobile device

76—step of presenting activity website on mobile device

78—step of collecting data provided to activity website on mobile device

80—step of marking the stopping point of data collection at website on mobile device

82—step of presenting opinion collection website on mobile device

84—step of collecting data provided to opinion collection website on mobile device

86—Domain Name Systems (DNS) data

88—URI

90—Global Positioning System (GPS) data

92—step of detecting NFC tag associated with an item

94—step of presenting opinion collection content on an item

96—step of receiving answer on an item

98—location

100—product category

102—product subcategory

104—product brand

106—seed opinion collection content

108, 110—new opinion collection content created based on seed opinion collection content

112—starting point of clip of interest

114—ending point of clip of interest

116—survey question stub

118—survey question

120—item to be aggregated

122—video entity

124—play button

126—slider track

128—progress button

130—opinion collection content family

132—items aggregated from a family of opinion collection contents

134—category representing items aggregated from a family of opinion collection contents

136—opinion collection question stub

138—input device

### PARTICULAR ADVANTAGES OF THE INVENTION

The choice of a user is non-conspicuous. When a user expresses an opinion, it is unclear to spectators whether the answer was “Yes” or “No.” The user can procure shoes with answers of any combinations. For instance, each of the left and right shoes can represent “Yes” or “No.” It is also possible that both left and right shoes can take on the same answer, i.e., “Yes” or “No.” In this case, the user may refrain from expressing his opinion if none of his answers corresponds to his intention.

Each NFC tag-reader pair has a range of operation of about 4 cm. By horizontally disposing an NFC centrally about a shoe sole, the Applicant discovered that the horizontal distance between each NFC tags pair disposed on two complementing shoes is sufficient to mitigate potential false readings taken by the NFC reader while ensuring that the intended NFC tag is sufficiently close to the NFC reader for detection of the NFC tag.

In one embodiment, various steps are eliminated for users to express opinions in public. In conventional evaluation of an opinion collection, each opinion collection content is paired with a user. Therefore, for the presentation of an opinion collection content, only one selection is expected. In the present opinion expression, one opinion collection content is paired with multiple users, thereby eliminating the need to individually presenting the opinion collection content to users. In yet another embodiment, the use of more than one point of NFC tag-reader acknowledgement enables collection of responses to opinion collection contents based on user experiences received just prior to the presentation of the opinion collection contents, thereby increasing the accuracy and relevance of the opinion collection content data received. In yet another embodiment, the opinion expression does not require NFC tags to be specifically programmed, thereby enabling the use of generically-programmed NFC tags. The URI of an opinion collection content is specified by the combination of two designators. In yet another embodiment, the present invention allows a user to aggregate opinion collection contents before the user is required to respond to one or more aggregated opinion collection contents. In yet another embodiment, the ability to allow creation of linked opinion collection contents or families of opinion collection contents, is provided. As the statistics of each member for an opinion collection content family is preserved, the sample size for an opinion collection content family as a whole is increased, thereby making statistical data more meaningful. As answer choices of such families may be collected and presented to users as collections of choices, advertisers may choose to use such collections of choices as an avenue to advertise. In yet another embodiment, there is further provided a media having different opinion collection contents associated with the media at different time frames such that suitable opinion collection contents may be presented to a user of the media within a specific time frame.

### DETAILED DESCRIPTION OF A PREFERRED EMBODIMENT

Various attempts have been made to gather public opinion via the internet, official opinion gathering practices and ad hoc and small scale opinions gathering via pen and paper. These attempts have resulted in varying degrees of success. Conventional opinion collection contents may be presented via online means to website targeted audience. For instance, an online search result corresponding to an automobile search inquiry may return an opinion collection content alongside contents relevant to gasoline prices. While this practice may be effective as an additional means for capture public opinion, there lacks a means for capturing opinions of the segment of society not willing to submit their opinions due to the expectation that the original content accessed may be compromised by the act of responding to such opinion collection contents or the user may be inadvertently navigating away from the original content. The Applicant has discovered various means for capturing public opinion that are unconventional and effective. Venues of large crowds, such as stadiums, concerts, arenas, fairgrounds, conventions and the like present opportunities for collecting public opinion. Advertisers of such events typically use QR codes to provide URIs to suitably equipped mobile devices for quicker access to URIs of products and services. As used herein, a mobile device includes a cellular phone such as iPhone®, Droid®, electronic touch pad such as iPod®, iPad®, Samsung Galaxy® and the like.

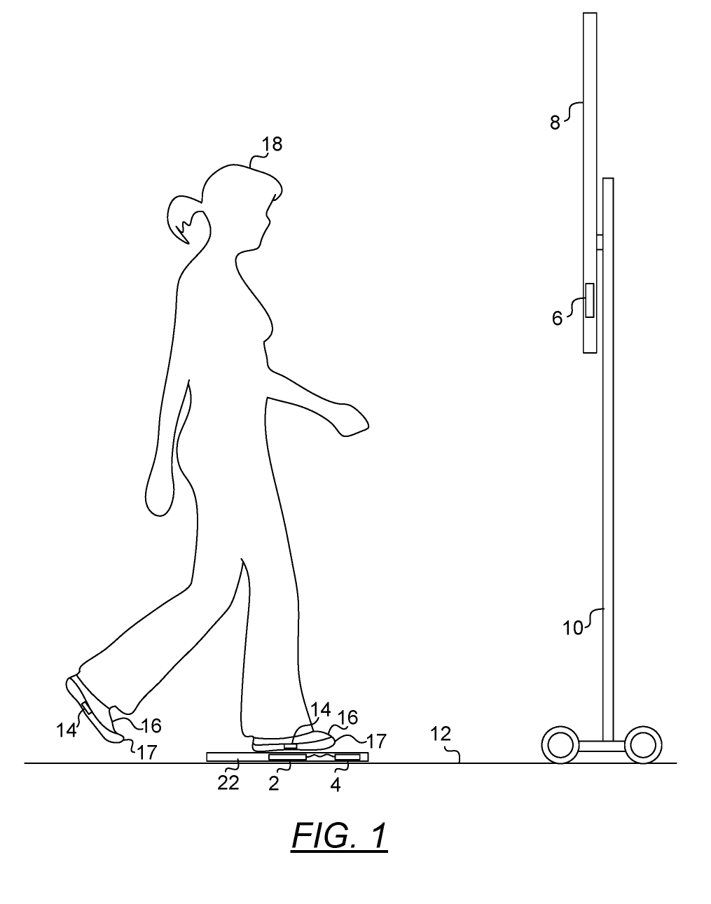

FIG. 1 depicts one embodiment according to the present NFC based opinion expression. This system comprises a pair of NFC tags 14, each tag represents an answer to an opinion collection content question. In one embodiment, one NFC tag 14 represents “Yes” and the other represents “No.” Examples of near field radio frequency (RF) communicators are defined in various standards for example ISO/IEC 18092 and ISO/IEC 21481 for NFC communicators, and ISO/IEC 14443 and ISO/IEC 15693 for near field RF communicators. The present opinion expression includes an NFC reader 2 configured to receive a signal from one of the pair of NFC tags 14, a display 8, a server (not shown in FIG. 1) adapted to store a plurality of opinion collection contents and their corresponding statistics and an application (also not shown in FIG. 1) configured for retrieving an opinion collection content from the server and displaying the opinion collection content on the display 8. The NFC reader acts as an initiator by generating a radio frequency (RF) field which powers the NFC tag (or passive target). Although being called a tag, an NFC tag can assume various form factors. An NFC tag can be a tag, sticker, card, etc. The present NFC tags 14 are preferably tags capable of embedment in shoe soles without affecting the comfort of the wearer. NFC tags measuring 0.15×0.15 millimeters in size and 7.5 micrometers thick (or the size of a small dot) have been made possible by Hitachi. The application is configured to associate a signal received from the pair of NFC tags to the opinion collection content and update the statistics of the opinion collection content in the server. The display is preferably large and capable of being viewed at a distance to attract attention of those present in its vicinity. Suitable displays include computer, projection, television (TV) screens, printed banners, posters and signs although screens of mobile devices and electronic touch pads may also be used for smaller venues. In the embodiment shown in FIG. 1, the present system further comprises a transmitter 4-receiver 6 pair configured for transmitting the signal from the NFC reader to the application, thereby enabling wireless connection between the signal and the application.

In one embodiment, the display is further operably coupled to an audio device configured to verbally express the opinion collection content presented on the display 8. This is especially useful for the visually impaired or children who have not mastered reading. In one embodiment, the display 8 is disposed at eye level to pedestrians and in the vicinity of a protective case 22 such that a user may more readily associate the display 8 to the protective case 22. The display 8 may be mounted on a wall or disposed on a stand 10. In practice, the present system is set up on busy pedestrian walkways, pathways and concourses in venues with large crowds and where it is easily accessible. As pedestrians walk by the display, their attention is hopefully drawn to the display 8.

An opinion collection content is presented on the display 22 at any time for a period of time. A new opinion collection is presented on the display 22 after the period of time in which the previous opinion collection was represented has expired. A list of opinion collections can be programmed to be cycled for an event. Any answers received during the display of an opinion collection content are automatically associated with the opinion collection content. When a user 18 is interested in providing an answer in response to an opinion collection content, he or she steps on the protective case 22.

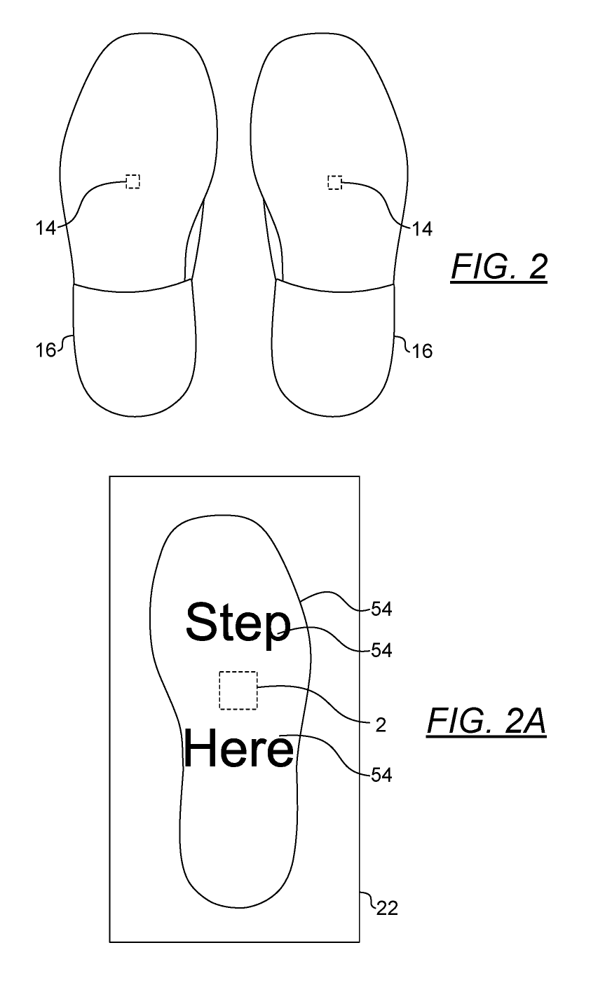

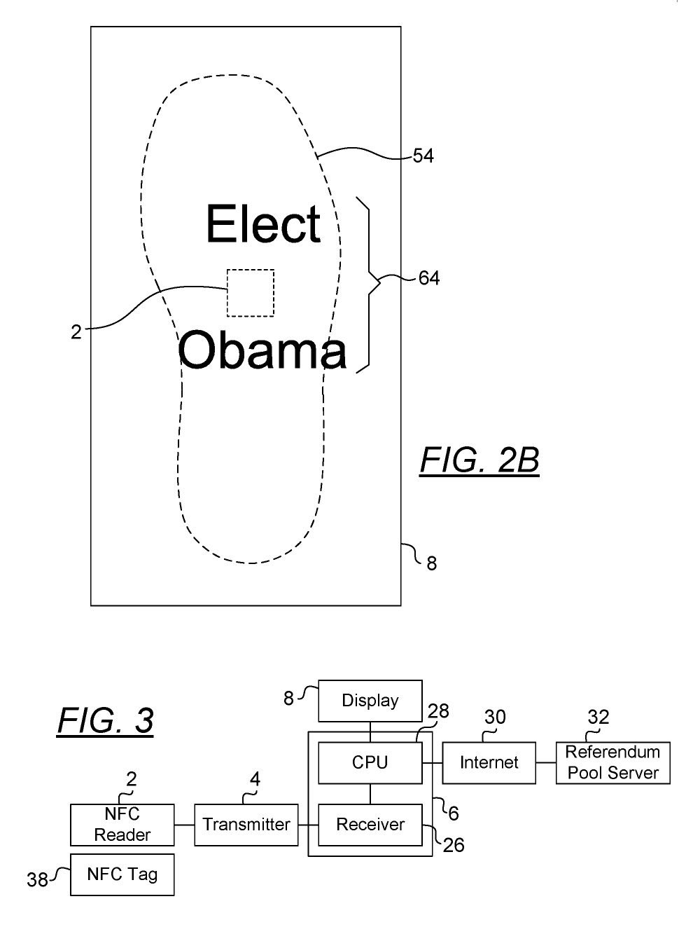

FIG. 2 is a bottom orthogonal view of a pair of shoes 16, each of the pair of shoes 16 having an NFC tag 14 affixed to its sole. FIG. 2A is a top orthogonal view of a protective case 22 according to the present opinion expression. For protection from environmental elements, each NFC tag 14 may be embedded in or formed integrally and within a shoe sole 17. In a preferred embodiment, the NFC reader 2 is embedded in a protective case 22 having an indicator 54 showing the case 22 is to be stepped upon. The indicator 54 on the protective case 22 helps indicate the approximate location where a shoe is expected. This indicator 54 ensures that an answer is properly entered as an NFC tag needs to be positioned within about 4 cm to an NFC reader 2 to successfully detect the NFC tag. The NFC's effective range also works toward its advantage. As a user stepped on the protective case 22, only the NFC tag disposed in the shoe 16 positioned atop the protective case 22 is detected and not the NFC tag disposed in the other shoe 16. FIG. 2B is a top orthogonal view of another embodiment of the present display 8. In this embodiment, an NFC reader 2 is embedded in a display 8 designed to be stepped upon. For example, an opinion collection content 64 “Elect Obama” is displayed along with the silhouette of a shoe as an indicator 54 to indicate that the display 8 is to be stepped upon. Similar to the protective case 22 of FIG. 2A, the display 8 is configured for placement on a floor. In yet another embodiment (not shown), the display 8 is a passive display such as printed poster or sign.

Applicant discovered that NFC tags are suitable for use as selections as the range of operation of the NFC tags-NFC reader is about 4 cm or less. The protective case 22 may be simply disposed on a floor 12 or it may be embedded in the floor 12 such that its top surface stays flush with the floor 12 to avoid tripping hazards. The indicator 54 can be any markings capable of guiding a user to step upon the indicator 54 with a shoe containing an NFC tag, such as arrows, text, silhouette of a shoe and the like. The NFC tag 14 may alternatively be affixed to another portion of a shoe 16 such as the insole.

The NFC tag 14 may alternatively be affixed to a surface of the outsole, preferably on an interior surface of a crease to avoid rubbing contact with a floor or grounds. A mark indicating the meaning of a corresponding NFC tag may additionally be made available on a concealed portion of a shoe while it is being worn, such as the insole or the vamp of the shoe. Alternatively, the meaning of an NFC tag is deciphered electronically using an application operably connected to an NFC reader. In practice, any left or right shoe may be manufactured with an NFC tag representing an answer of “Yes” or “No.” Therefore a particular shoe does not necessarily carry a specific meaning and therefore enables one to conceal the answer to spectators.

FIG. 3 is a block diagram of the embodiment of FIG. 1. An application running in central processing unit (CPU) 28 first retrieves an opinion collection content via the internet 30 from an opinion collection content pool server 32 and displays it on a display 8. Reference is made to Applicant's copending U.S. Pat. Pub. No. 2012/0290556 for an opinion collection pool server 32, wherein the teachings of an opinion collection content pool server is hereby incorporated by reference in its entirety. An NFC reader 2 is operably connected to a transmitter 4 which transmits a signal received from NFC tag 38 when NFC tag 38 is disposed in detection vicinity of the NFC reader 2. The signal is then received by the receiver 26 operably connected to the application running on the CPU 28. The application then deciphers the signal to yield a result and associates the result to the opinion collection content and transmits the result to the opinion collection content pool server 32. The result can be a “Yes” or a “No.”

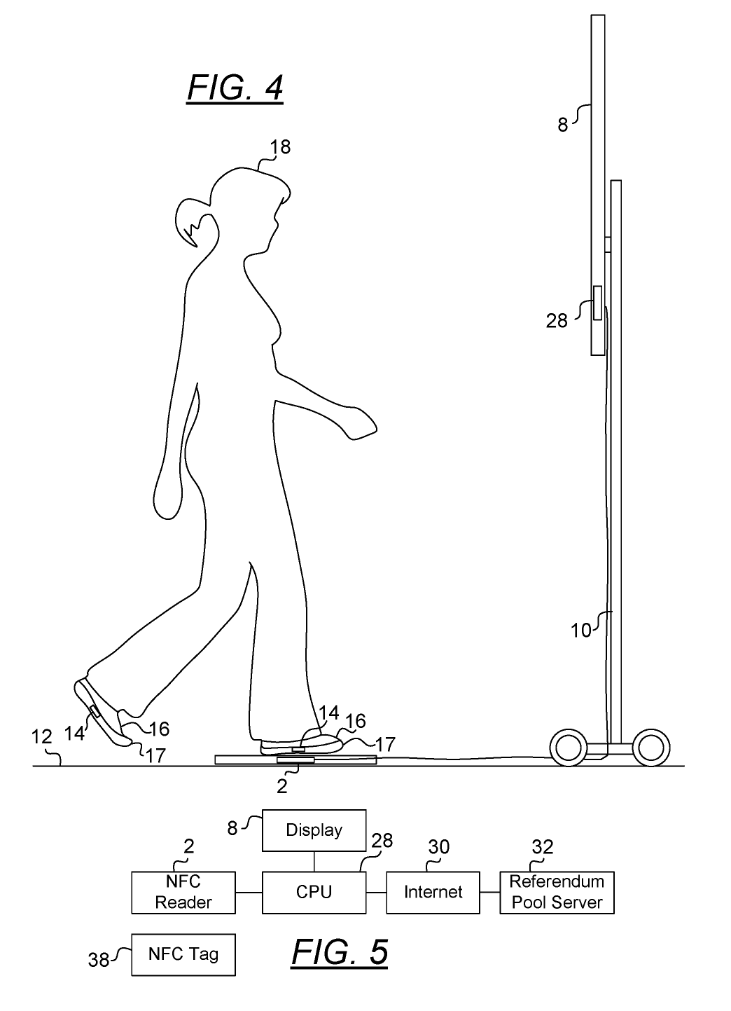

FIG. 4 depicts another embodiment according to the present opinion expression. In this embodiment, the NFC reader 2 is connected via hardwire to the CPU 28, thereby eliminating the need for a transmitter-receiver pair depicted in FIG. 1. FIG. 5 is a block diagram of the embodiment of FIG. 4. It shall be noted that the transmitter-receiver pair 4, 26 has been replaced with hardwire connection.

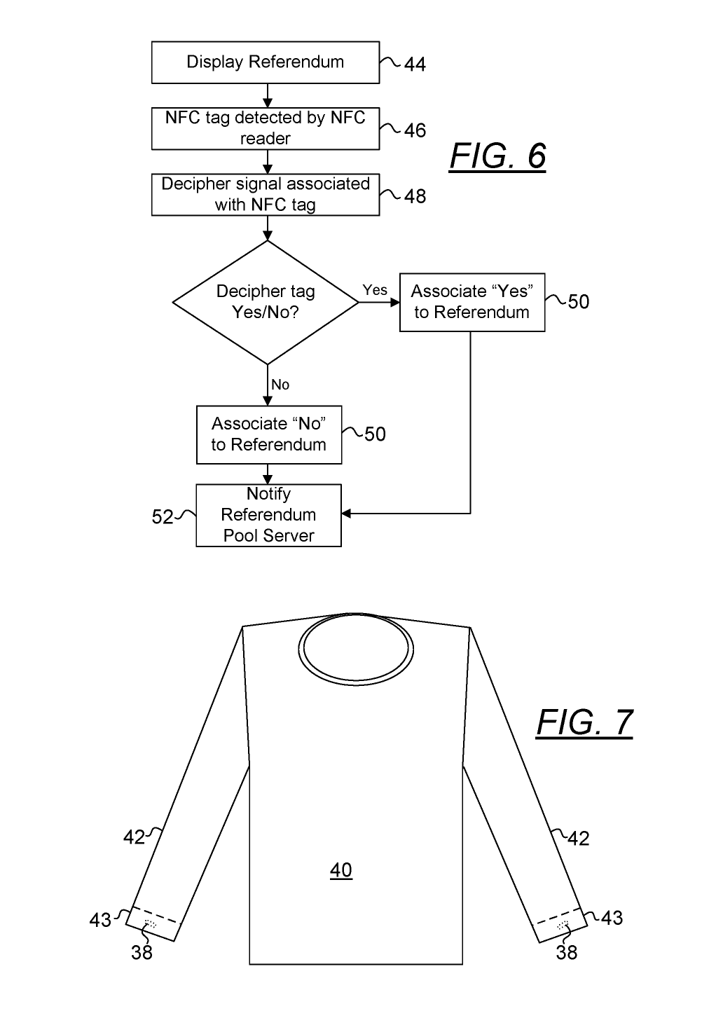

FIG. 6 is a flow diagram describing an exemplary method for receiving and tallying an answer stored on NFC tags according to an embodiment of the present invention. In step 44, an opinion collection content is retrieved from an opinion collection content pool server and presented to a display. This is followed by step 46 where an NFC tag is detected by an NFC reader. In step 48, a signal associated with the NFC tag is deciphered to yield a result. The result can be a “Yes” or a “No.” In step 50, the result is associated with the opinion collection content during the display of which the signal was received. This is followed by step 52 where the opinion collection content pool server is notified of or updated with the result of the opinion collection content.

FIG. 7 is yet another example of an object where the present invention can be suitably applied. One NFC tag 38 is disposed within the cuff 43 of each sleeve 42 of a shirt 40. Similar to the shoe concept, selection of an opinion is carried out by bringing an NFC tag close to an NFC reader. In this case, an NFC reader is preferably mounted at a height convenient for a wearer of the shirt 40 to expression an opinion using one of the NFC tags in disposed in a cuff.

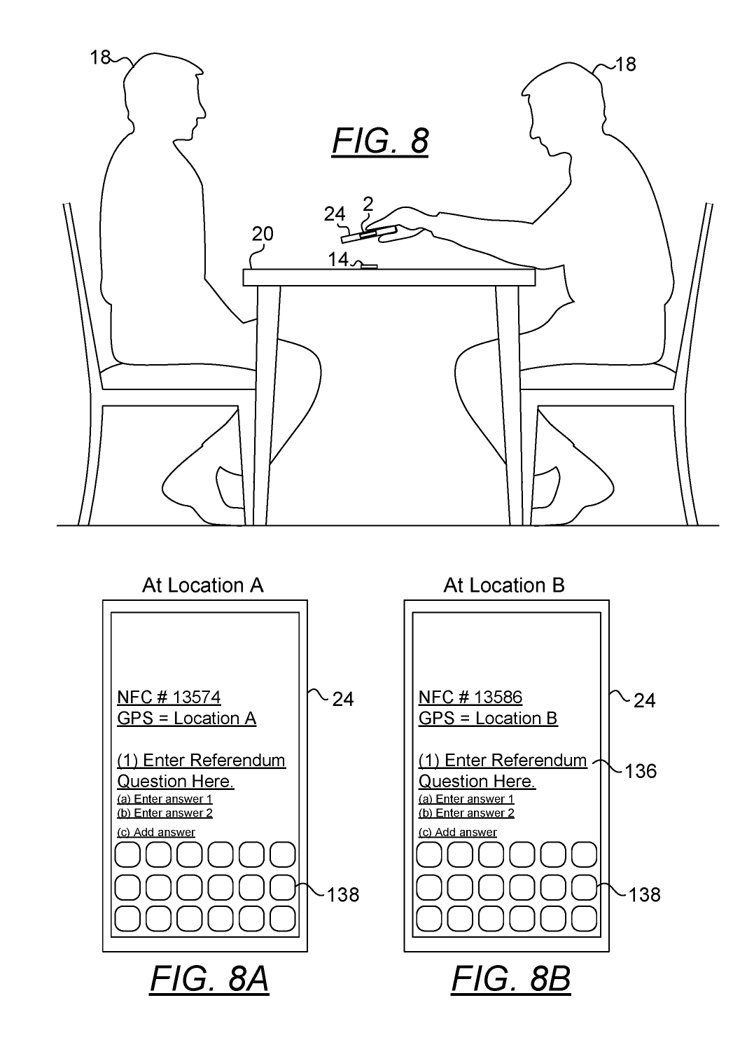

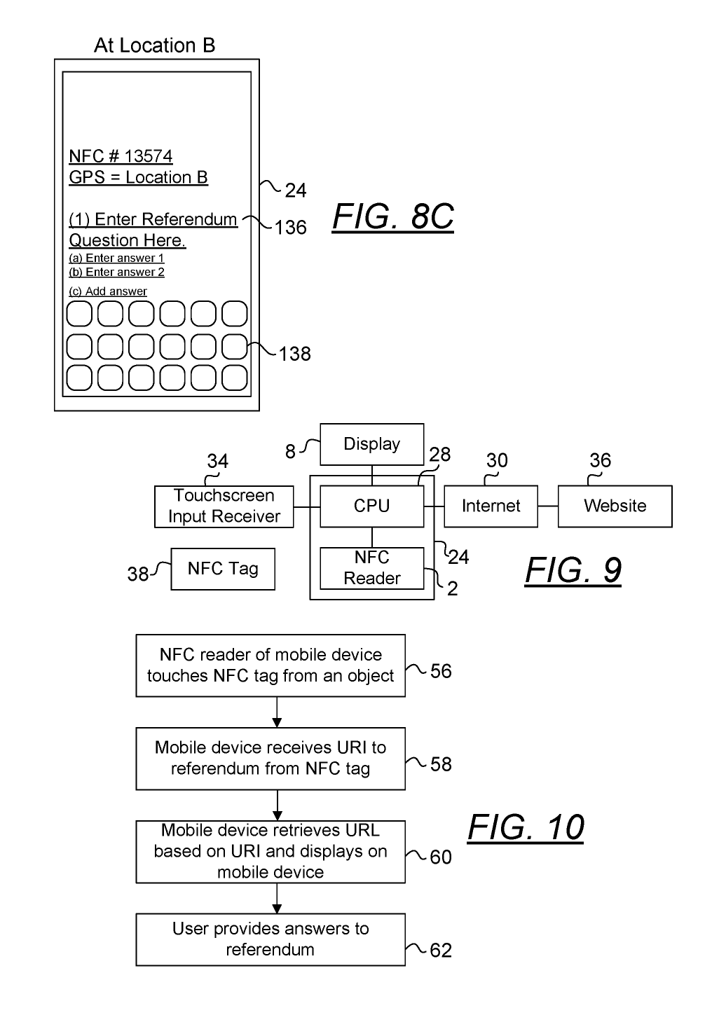

FIG. 8 depicts yet another embodiment according to the present NFC based opinion expression. Rather than having a user enter the entire URI via keying, the user may simply touch a mobile device 24 against the NFC tag 14, prompting the retrieval of an opinion collection content website URI based on the URI stored in the NFC tag. In this example, a restaurant patron 18 accesses an opinion collection content by touching the mobile device 24 against the NFC reader 14. A sample opinion collection content presented at the mobile device 24 may read “Would you visit our restaurant again?” A choice of “Yes” or “No” is presented on the mobile device 24. The patron can then enter one of the answers. Armed with such opinion collection content results, the restaurant management may focus on areas of improvement. In contrast to a QR code, the use of an NFC tag-reader pair eliminates the need to scan a QR code. Scanning a QR involves turning on a visual capture device such as a camera and appropriate lighting which is not always possible in public locations. Further, it can take several minutes or several trials to successfully read a QR code. An NFC tag-reader therefore eliminates unnecessary steps in capturing a QR code and provides a speedier means to retrieve a website. In addition to providing a website for access to an opinion collection content, the website can alternatively include additional information such as food and drinks menu, special offers, etc. The embodiment disclosed in FIG. 8 is not limited to restaurant settings. NFC tags may also be attached to stadium seats or other public venues where rapid retrieval of a website URI is critical. For example, in a sporting event, an audience may access an opinion collection content at his seat to weigh in on a penalty call of an official.

In another aspect, the use of an NFC tag extends beyond the purpose of opinion collection content data collection. If necessary, a website configured for receiving text, an image or otherwise the identity of a specific NFC reader is used, can be used to provide proof of the presence of the specific NFC reader. For example, a popular tourist spot may be coupled with one or more NFC tags. As proof that a person has been to the tourist spot, the person may use his or her NFC reader-equipped mobile device to detect the presence of the NFC tag or tags.

FIG. 8A depicts an interaction area through which an opinion collection content can be created. In one embodiment, the present NFC based opinion expression is used as an interface for receiving opinion collection contents. If the URI of FIG. 8 returns no opinion collection contents, an interaction area as shown in FIG. 8A is used to receive opinion collection contents from a user via input device 138. An opinion collection content question stub 136 is provided to facilitate creation of an opinion collection content question. After an opinion collection content has been created, subsequent engagement of the NFC tag of FIG. 8 causes the opinion collection content question to be presented. In one embodiment, an opinion collection content question stub 136 is presented regardless of the number of opinion collection contents the URI points to such that further creations of opinion collection contents are encouraged. In one embodiment, the author of an opinion collection content may control access to the opinion collection content, e.g., by requiring a code or password set by the author. For example, a member of a family may view the choices made by the same family member or another family member in a restaurant in the past by accessing one or more opinion collection contents in a group accessible only by providing correct credentials.

FIG. 8B depicts an interaction area through which an opinion collection content can be created and where the interaction area is located in a mobile device having detected an NFC tag that has a different identifier than the NFC tag of FIG. 8A. Note that the detected NFC tag number is 13574 in FIG. 8A and 13586 in FIG. 8B. It can then be said that the URI shown in FIG. 8A is unique in view of the URI shown in FIG. 8B. In such an example, the unique URI alone is sufficient to distinguish one NFC tag from another. In another example, batches of identical NFC tags (those having identical URIs) may be manufactured at a lower cost as differentiation is not required. FIG. 8C depicts an interaction area or interface through which an opinion collection content can be created and where the interaction area is located in a mobile device having detected an NFC tag that has an identifier that is identical to the NFC tag of FIG. 8A. In this instance, a differentiator indicating a different geolocation is used to indicate that the detected NFC of FIG. 8C should be associated with a different URI than the URI of FIG. 8A. Note that the Global Positioning System (GPS) data of FIG. 8C indicates a location that is different than that of FIG. 8A. For geographically diverse applications, Domain Name Systems (DNS) data may also be used.

FIG. 9 is a block diagram of the embodiment of FIG. 8. An NFC reader 2 is operably connected to a CPU 28 and configured to detect an NFC tag 38 disposed in detection vicinity of the NFC reader 2. Upon receiving a URI stored in an NFC tag 38, the NFC reader 2 communicates this signal to an application running in CPU 28 which then uses this URI to retrieve an opinion collection content website 36 via the internet 30 and displays it on a display 8. In one embodiment, the display 8 is operably coupled to a touchscreen input receiver 34, wherein an answer of “Yes” or “No” can be entered in response to the opinion collection content.

FIG. 10 is a flow diagram describing an exemplary method for retrieving and using a URI stored on an NFC tag according to an embodiment of the present invention. In step 56, an NFC reader of a mobile device is touched upon an NFC tag attached to an object. In this example, the object is a restaurant table. Such NFC tag 38 may alternatively be attached to other objects easily accessible to potential users, such as an exit door or payment counter at the restaurant. In step 58, an application of the mobile device receives a URI stored in the NFC tag. The mobile device then retrieves a URI based on the URI received from the NFC tag in step 60. This is followed by the user of the mobile device being presented with an opinion collection content associated with the URI. The user can then choose to respond to the opinion collection content in step 62 by selecting an answer “Yes” or “No.”

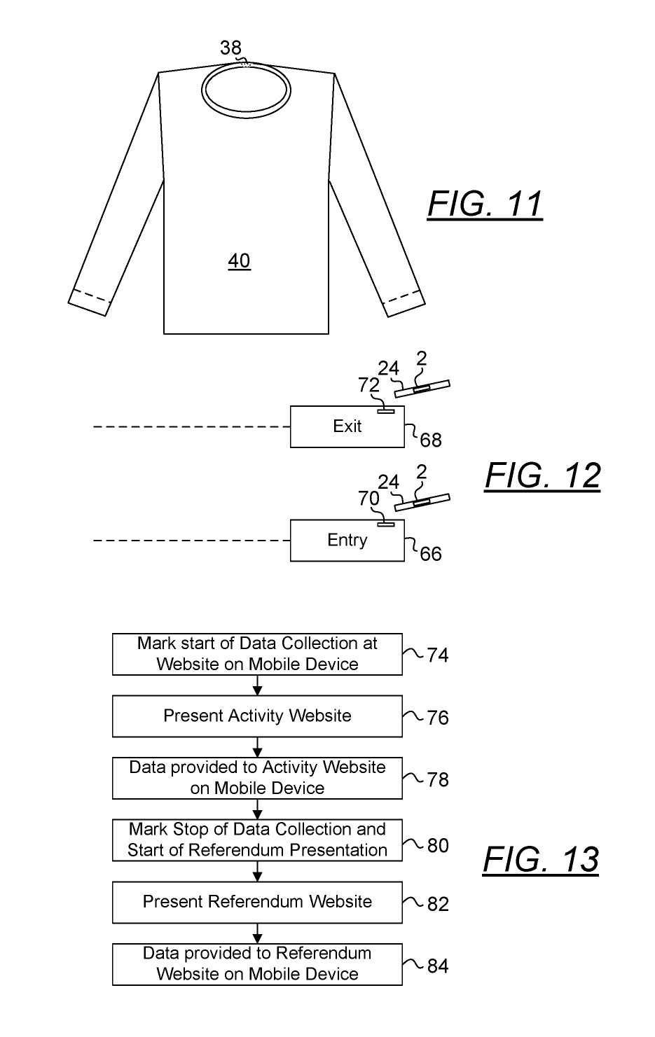

FIG. 11 is yet another example of an object where the present invention can be suitably applied. An NFC tag 38 may be affixed to a shirt to enable swift access of an opinion collection content URI associated with the shirt. Such opinion collection content may be “Would you buy a shirt of this design again?—Yes or No?”

FIG. 12 depicts yet another embodiment according to the present NFC based opinion expression where a pair of NFC tags is used. An NFC tag 72 is provided at an entry location 66 and another 74 at an exit location 68 of a venue. Upon entering a venue, a user may simply touch a mobile device 24 against NFC tag 72, prompting the retrieval of a website corresponding to the venue and a timestamp is cached. A venue can be a restaurant, checkout counter of any store or any locale where at least a task is to be performed, can only be performed or preferably be performed at the locale. One such task is the order of food items as the food items can only be received or consumed in person. In many occasions, ordering of food from a restaurant is preferably done at the restaurant as a patron may have additional questions about the food items that may not be communicated merely through a website. However, awaiting for services in long lines have been the norm of today's society. Applicant discovered that there are opportunities to turn waiting time into productive time, such as in providing a tool for the patron to order food while he or she waits in line for service at the counter. In addition, the patron also does not need to first look up the contact information of the appropriate restaurant from which food is to be ordered as in the case where food is ordered remotely. At the time of food ordering, various pieces of information may be cached in a server, such as the types and quantities of food ordered, the timestamp at which an order is placed, etc. This information may be used for statistical analysis at a later time to improve upon the efficiency and speed of the food service. As the patron is already physically present at the restaurant, ordering of food is delayed until about the moment the food item is consumed to ensure just-in-time preparation of food for freshness of the prepared food. During exit from the restaurant, the patron may simply touch a mobile device 24 against the NFC tag 74, prompting the retrieval of a website which enquires about the experience the patron had in the restaurant and another timestamp is cached. For example, the patron may be asked the following question:

“Do you like the food choices you just had?

______Yes ______No”

In one embodiment, and in an effort to make opinion collection content taking even simpler, the answer choices of “Yes” and “No” may be presented as color coded buttons. For example, the “Yes” button may be green colored and the “No” button may be red colored. Armed with the pieces of information received due to responses of a patron to the websites during entry and exit of the restaurant, a profile can then be deduced. This profile may include information such as the duration of stay at the restaurant (i.e., by subtracting the timestamp at entry from the timestamp at exit), the percentage of patrons using this technology in simplifying food ordering, the time periods over the course of business hours in which this technology is used in food ordering (such that appropriate levels of staffing of personnel can be determined). The act of collecting patrons' opinion immediately after a service has been delivered also increases the relevance and accuracy of such opinion to the service and/or product provider, i.e., the restaurant owner in this case. In contrast to the use of GPS in determining location and temporal appropriateness in serving an opinion collection content, the present invention is superior in that the use of NFC presents a service or product provider with targeted patrons, thereby increasing the value of such service to the patrons. With GPS technology, it is often impossible to determine the intention of a user simply by detecting the user's presence in an area. In addition, in order for GPS technology to function properly for location tracking, the ability to broadcast location information may be necessary. As such, the use of GPS technology may be a cause for privacy concern with mobile service providers. With the present invention, such concern is considered non-existent as the information considered vulnerable to eavesdropping must be processed before compromising details can be deduced. In addition, unlike GPS systems, the present invention does not require periodic broadcast of GPS signals which can significantly increase power consumption of a mobile device. One additional concern of the use of GPS technology lies in the authenticity of GPS data which can be manipulated or “faked.” Inaccurate GPS data would defeat its use in the present invention.

FIG. 13 is a flow diagram describing an exemplary method of the present invention for conducting an opinion collection content by incorporating more than one NFC tag. In step 74, a starting point of data collection is marked by the detection of a first NFC tag, e.g. NFC tag 70, by an NFC reader on a mobile device. As a result, an activity website is then presented on the mobile device as shown in step 76, prompting the user of the mobile device to provide a response. The activity website includes, but not limited to, a food ordering website, a television program, a game program, etc. In step 78, data, such as food order, is subsequently provided by the user and collected by the activity website in response to the food ordering website and cached in a server. In step 80, a stopping point of data collection is marked by the detection of a second NFC tag, e.g. NFC tag 72, by the NFC reader on the mobile device. As a result, an opinion collection content website is then presented on the mobile device as shown in step 82. A response to the opinion collection content website is then provided by the user in step 84.

In another embodiment, the first and second NFC tags may alternatively be NFC readers and the mobile device may alternatively include an NFC tag provided that an NFC device on each of the entry and exit locations is configured for complementary operation with an NFC device on the mobile device.

In one embodiment, the present NFC based opinion expression is further coupled with a digital currency or an electronic money and online payment system that is anonymous in nature. Such digital currency includes, but not limited to, any social digital currency, Facebook® credits, gift cards, etc. Upon taking an opinion collection content, a user may be rewarded with digital currency such that further participation of similar opinion collection contents is encouraged. Such reward may then be transacted for purchases of real life goods.

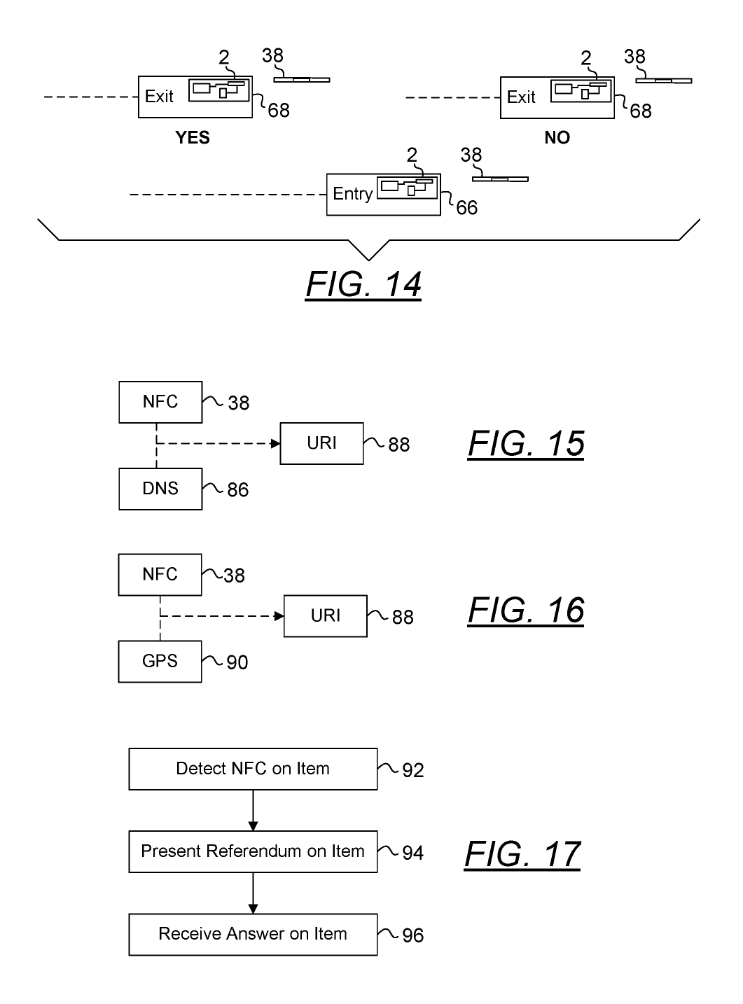

FIG. 14 is yet another embodiment according to the present NFC based opinion expression, depicting the use of three possible NFC communication points. In this case, three NFC readers 2 are provided, i.e., one at an entry location 66 and two at an exit location. One NFC reader at exit is labeled “YES” to represent an answer of “Yes” and the other is labeled “NO” to represent an answer of “No.” The entry location preferably includes a first display for displaying an activity website while the exit location preferably includes a second display for displaying an opinion collection content website based on a response to the activity website. Similar to the embodiment disclosed in FIG. 12, in this embodiment, two points of NFC communication are effected, i.e., one at the entry point and the other at one of the two NFC readers 2 at the exit point. This setup however allows the use of an NFC tag on the part of a user, thereby simplifying the equipment required on the part of the user for taking an opinion collection content. In selecting an answer to an opinion collection content, the user simply touches an NFC tag against one of the exit location NFC readers depending on the desired answer, prompting the submission of such answer to a server tasked in collecting opinion collection content date. In one embodiment, such NFC tag is embedded in a card for ease, convenience and security in transporting the NFC tag. Such NFC tag may alternatively be embedded in any substrate material that is easily stored and portable.

FIG. 15 is yet another embodiment according to the present NFC based opinion expression, depicting the use of an additional designator in combination with an NFC to more specifically define a URI 88. The NFC includes an emitter (powered or unpowered) configured to emit a signal representing a designator. A designator may be a code, e.g., “X123,” that represents an item. The additional designator may be a code that represents a location, e.g., a postal zip code, e.g., 12464 and may be obtained via a controller configured to access, via a communication network, a database storing such information where the location reflects the location of the controller accessing the database. FIG. 16 is yet another embodiment according to the present NFC based opinion expression, depicting the use of yet another additional designator in combination with an NFC to more specifically define a URI. In some previously disclosed embodiments, each NFC tag specifies an exact URI, therefore requiring each NFC to be specifically programmed or constructed for its specific use or retrieval of a specific URI. For example, for a franchise business which has many locations, each location has a specific geographical location, may sell specific items unique to the location, etc., thereby requiring a uniquely programmed NFC for each location. The Applicant discovered several benefits of using an additional designator in combination with a generic NFC to specify a unique URI. Using generic NFC, the purpose of identifying the presence of a reader of an NFC tag in the vicinity of the NFC tag is ensured. For instance, the reader is physically and functionally attached to a mobile device, such as a phone, computer, etc. The presence of a target audience, who is the assumed to be the carrier of such mobile device, can then be ascertained. In another example, the NFC tag may be used to specify an item. The identity of the location in which the NFC is used, is determined by an additional designator. An additional designator can be Global Positioning System (GPS) data 90 or Domain Name Systems (DNS) data 86. The Domain Name Service of the DNS resolves queries for these names into Internet Protocol (IP) addresses for the purpose of locating computer services and devices worldwide. GPS data specifies the geographical information of a location. If either additional designator is used, additional look-up may be required which correlates raw or rudimentary location information with a well-established map.

The practice of establishing location information based on DNS is not new. Reference is made to U.S. Pat. No. 8,073,972 for a system and method for location discovery based on DNS, the specification for which is incorporated by reference in its entirety herein. When used together in an opinion collection content creator, a generic NFC tag specifies the presence of a reader at a location and the additional designator specifies the geographical details of the location, thereby serving as resources for retrieving and interacting with one or more relevant readily available opinion collection contents that are based on the data of the NFC tag and the additional designator, from a specific URI or creating one or more new opinion collection contents that are stored at a specific URI. In one embodiment, there is further provided a second NFC programmed to store the additional designator, e.g., a location as one capable to be reported by a DNS or GPS system. In this case, in order to specify an item and its location, only two generically programmed NFC tags are required. Again, a uniquely programmed NFC tag which specifies an item and its location is not required.

Disclosed herein below is an example illustrating the manner in which the two-designator system can be used. In this example, a drink manufacturer is interested in finding out whether geographical location plays a part in the popularity of a newly introduced drink that is being sold across two geographical regions. A bottle containing the new drink is tagged with at least one NFC tag where it indicates the item, e.g., the type of drink, e.g., a specific-branded drink. In one embodiment, a mobile device capable of interacting with the at least one NFC tag is provided. In one embodiment, the same mobile device is configured to be capable of obtaining a second designator via a secondary device. In one embodiment, the secondary device is an NFC device, e.g., a second NFC tag including a second designator which indicates the location of tag. The second NFC tag may be located in close proximity to the NFC tag used for indicating the item and attached to the item just as the NFC tag used for indicating the item. In another embodiment, the secondary device is a DNS device and/or GPS device, each capable of retrieving information indicating the location of the mobile device. An application capable of communication, e.g., via Ethernet, with a server is further provided on the mobile device where the server is adapted to store a plurality of location-based opinion collection contents. There is further provided an opinion collection content creator including a means for retrieving at least one location-based opinion collection content corresponding to the first and second designators from the server. In one embodiment, at least one location-based opinion collection content is retrieved from one or more relevant readily available opinion collection contents that match the item at the indicated location, from a specific Universal Resource Identifier (URI) corresponding to the server. One or more new location-based opinion collection contents that relate to the item at the location are created and stored in the server such that the first designator indicates only the item and without association to the location, thereby enabling the use of a generically-programmed inexpensive NFC device for the creation of a location-based opinion collection content.

In use, when a mobile device is brought within functional proximity of the NFC tag indicating the item, e.g., item X and also the second NFC tag (if one is used) in a first geographical region, e.g., geographical region 1, an opinion collection content may be created, e.g., “Do you like item X in geographical region 1?” An answer to this question is then cached, e.g., in the server such that it can be retrieved at a later time. In a second geographical region, a similar item X is now associated with a second designator that indicates a second geographical region, e.g., geographical region 2. Here, an opinion collection content may be created to read “Do you like item X in geographical region 2?” Again, an answer to this question is then cached, e.g., in the server such that it can be retrieved at a later time. In summary, when used together in an opinion collection content creator, a first NFC tag identifies the item and the second or additional designator specifies the geographical location of the item. In yet another embodiment, more than two designators are used. For instance, a third designator, e.g., contained in an NFC tag, is used to indicate another item, e.g., item Y. Here, an opinion collection content may be created to read “Do you like item X and item Y in geographical region 2?” if it is determined that both of these items are located in geographical region 2.

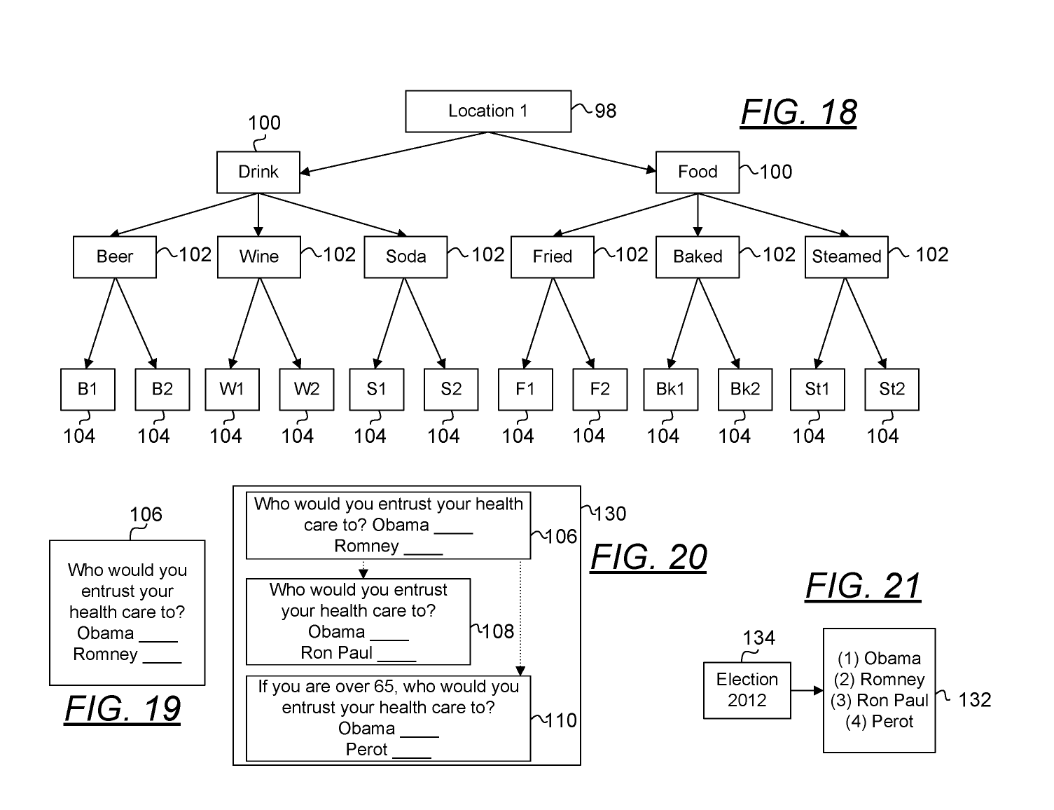

FIG. 17 depicts a series of steps which when repeated can be used to build a hierarchy of items. First, an NFC tag attached to an item is detected as in step 92. A description of the item is then harvested and used in the construction of an opinion collection content as in step 94. An answer is then received for the opinion collection content as in step 96. FIG. 18 depicts a hierarchy of items built by submissions of NFC tag detections as shown in step 92 of FIG. 17. In this example, each item may be classified in the following manner at a location 98. A broad category 100 of “drink” contains any types of beverages 102 including beer, wine and soda. The drinks B1, B2, W1, W2, S1 and S2 (104) are therefore subsets of the different types of beverages 102. Likewise, a broad category 100 of “food” contains any types of food 102 suitable for consumption by humans. The foods F1, F2, Bk1, Bk2, St1 and St2 (104) are therefore subsets of the different types of food 102. Although an inventory control system of a business may already include such hierarchy of items, the construction of such hierarchy is initiated by the interaction of local users, thereby representing items that are actually accessed by local users as the users are required to be present to interact with NFC tagged items. Further, the business is not required to provide a list of items for sale, which is often proprietary, to the public or an organization performing statistical data collection or analysis. As demonstrated in FIGS. 17 and 18, each item in the hierarchy can potentially be linked to one or more opinion collection contents, thereby creating a broad network of items which local users have experienced. The Applicant discovered that the statistical significance of such opinion collection contents is weighed more heavily than opinion collection contents presented without association to physical items as the former reflects opinions of the users often at or near the point of purchase or consumption.

FIG. 19 depicts a seed opinion collection content 106. FIG. 20 depicts an opinion collection content family 130 created based on the seed opinion collection content 106 of FIG. 19. Upon viewing and/or responding to a seed opinion collection content 106 such as the one shown in FIG. 19, a viewer may wish to create an opinion collection content that is slightly altered or opinion collection content answer choices that are slightly different. In order to preserve any statistical data already collected for a seed opinion collection content 106, one or more opinion collection contents may be created from the seed opinion collection content 106. Details such as the time at which an opinion collection content is created and the time at which a response is received may also be cached and subsequently used for statistical purposes. By the same token, the newly created opinion collection contents 108, 110 may also serve as seed opinion collection contents from which additional or new opinion collection contents are derived. Referring to FIG. 20, the derived opinion collection contents 108, 110 are provided as a family 130 or set to a viewer such that the viewer may be shown a family of related opinion collection contents instead of a single opinion collection content. The viewer is therefore presented with more choices and more likely to be interested in responding to one or more opinion collection contents and/or creating one or more new opinion collection contents. For example, a first viewer first created the following seed opinion collection content 106:

“Who would you entrust your health care to?

Obama ______

Romney ______”

Another viewer who accessed the seed opinion collection content 106 decided that the answer choices are not suitable and that alternative answer choices are desired. Therefore the same opinion collection content question with different answers is created as follows:

“Who would you entrust your health care to?

Obama ______

Ron Paul ______”

Another viewer who accessed this opinion collection content family 130 after the creation of the seed opinion collection content 106 or even after the creation of the later created opinion collection content 108 decided that the opinion collection content question may be clarified by altering the opinion collection content question, therefore creating opinion collection content 110 to more specifically target certain segment of the population, i.e., anyone over the age of 65.

“If you are over 65, who would you entrust your health care to?

Obama ______

Perot ______”

In another embodiment, the concepts revealed in FIGS. 19 and 20 may be further associated with an NFC trigger, i.e., the link to the opinion collection content family 130 is defined by the URI embedded in an NFC tag. In one embodiment, the answers of each family of opinion collection contents may be aggregated and presented to a user such that one or more answers of the aggregate may be used as a basis from which an action is taken. For example, FIG. 21 displays an aggregate of answers gathered from the opinion collection content family of FIG. 20 under a category called “Election 2012.” Upon creating or modifying a family of opinion collection contents, the user has an option to create a category 134 and an aggregate of answers 132 which is linked to this category 134. One example for taking advantage of such aggregation of items has to deal with the facilitation of advertisement presentation where such aggregation of items is made available to an advertiser. The advertiser is given an option to select one or more answers from the aggregate with which an advertisement is to be concurrently displayed. For instance, if “(3) Ron Paul” is selected to be associated with an advertisement, the advertisement is displayed when opinion collection content 108 is being viewed. Unlike advertisements which utilize conventional keyword searching to select target URIs with which to display advertisements, FIG. 21 depicts a grouping of items which is more targeted to a specific category, thereby better able to engage the viewership of the advertisements. For example, a conventional keyword search of “Ron Paul” may return any and all URIs having text including the words “Ron” and “Paul,” which can be numerous. Various other pieces of statistical data of the opinion collection contents of the opinion collection content family may also be aggregated to aid an advertiser in selecting an answer as a target for an advertisement. Such pieces of data include, but not limited to, the size of polls received for each opinion collection content, the number of answers in an aggregate and the expanse of a family of opinion collection contents or the number of opinion collection contents in an opinion collection content family, etc.

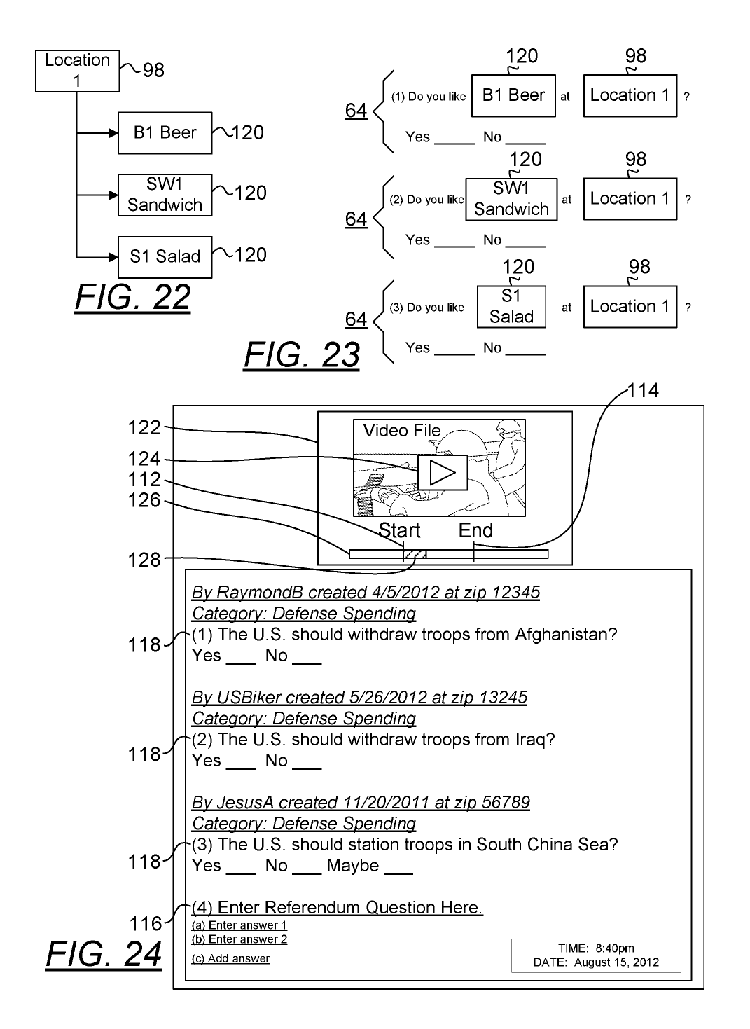

In yet another embodiment of the present invention, a mechanism for a user to aggregate at least two opinion collection contents prior to responding to the previously collected opinion collection content, is provided. FIG. 22 is a block diagram depicting an aggregation of items at a location. FIG. 23 is a block diagram depicting aggregated items 120 at a location and an opinion collection content 64 associated with each of the items. In this embodiment, a plurality of opinion collection contents 64 may be aggregated by a user, each associated with an item 120 prior to the time at which the user chooses to respond to the opinion collection contents 64. As each item is detected, it is added to a list of opinion collection contents. In this example, a template “Do you like blank1 at blank2” is used where a newly detected item is inserted in the space of blank1 and the location information, such as, “location 1” is inserted in the space of blank2. After each opinion collection content is built, the user has a choice to answer one or more opinion collection contents presented to the user immediately or until all opinion collection contents have been collected or aggregated. Therefore the user has a choice to either respond to one or more opinion collection contents at any time or all at once. A new set of opinion collection contents is aggregated at a new location 98, i.e., when the location is no longer “location 1.”

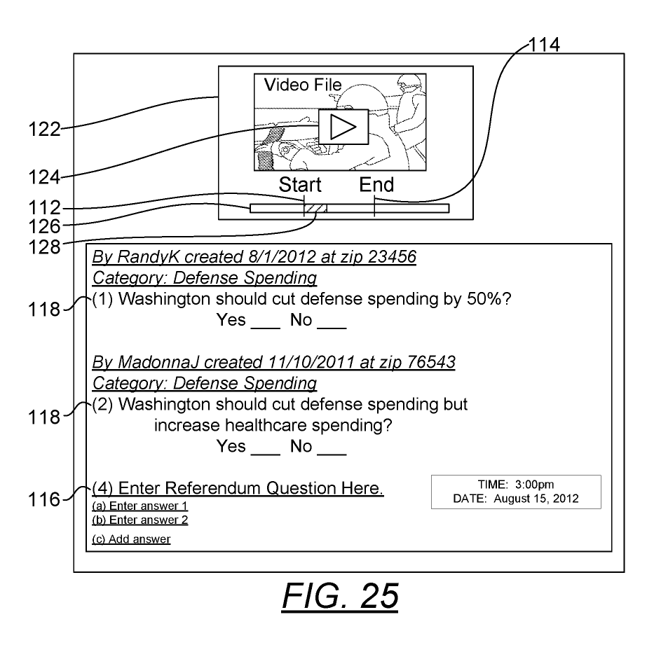

In yet another embodiment of the present invention, the concept of time frame is incorporated in an opinion collection content. FIG. 24 is a diagram depicting a video-type survey construction and survey taking interface at a first time stamp. FIG. 25 is a diagram depicting a video-type survey construction and survey taking interface at a second time stamp that is different time from the time stamp shown in FIG. 24. In one embodiment as shown in FIGS. 24 and 25, an opinion collection content system including a video entity 122, one or more opinion collection content questions 118, a mechanism for creating new opinion collection contents using a stub 116 and a mechanism for selecting one or more opinion collection content questions to be displayed at a particular time frame, is provided. In another embodiment as shown in FIGS. 24 and 25, an opinion collection content system is configured such that the user's attention can be focused only on a segment of a video or audio file, where a means for marking a playback segment is provided. At least a pair of markers including a starting marker 112 and an ending marker 114 is provided to mark a segment of interest within the at least one type of media or movie in this example. This feature is especially useful if the video or audio file is lengthy and there exists at least one point of interest embedded within the file or not easily pinpointed. Referring to FIG. 24, as the play button 124 is pressed, the video plays from starting marker 112 to ending marker 114 on the slider marker 126 as indicated by the progress button 128 and the following set of opinion collection contents is displayed when this segment is selected at the time frame including 8:40 pm, Aug. 15, 2012. It shall be noted that the author of each opinion collection content, the category in which each opinion collection content belongs, the date on which each opinion collection content was created and the zip code or location at which each opinion collection content was created, are further displayed. For instance, the opinion collection content question “(1) The U.S. should withdraw troops from Afghanistan?” was created or posted on Apr. 5, 2012 at zip code 12345 by a user called “RaymondB” and was categorized in the “Defense Spending” category. A viewer can therefore request to view opinion collection contents created by certain individuals or opinion collection contents belonging to certain categories.

“By RaymondB created 4/5/2012 at zip 12345

Category: Defense Spending

(1) The U.S. should withdraw troops from Afghanistan?

Yes______ No______

By USBiker created 5/26/2012 at zip 13245

Category: Defense Spending

(2) The U.S. should withdraw troops from Iraq?

Yes______ No______

By JesusA created 11/20/2011 at zip 56789

Category: Defense Spending

(3) The U.S. should station troops in South China Sea?

Yes______ No______ Maybe______”

It shall be noted that, for example at another time frame including 3:00 pm, Aug. 15, 2012, the following set of opinion collection contents is displayed instead of the set of question displayed at 8:40 pm, Aug. 15, 2012.

“By RandyK created 8/1/2012 at zip 23456

Category: Defense Spending

(1) Washington should cut defense spending by 50%?
Yes______ No______

By MadonnaJ created 11/10/2011 at zip 76543

Category: Defense Spending

(2) Washington should cut defense spending but increase healthcare spending?
Yes______ No______”

Such selective display of different opinion collection contents at different time frames enables the opinion collection contents to be tailored to their intended audience. For example, a typical afternoon audience may be more mature in age and experience and therefore would gravitate towards opinion collection contents related to policy making than opinion collection contents seeking an emotional response. Therefore, by introducing the time frame concept, the user of a video can selectively present, respond to or create opinion collection contents at various time frames. In another embodiment, the concepts revealed in FIGS. 24 and 25 may be further associated with an NFC trigger, i.e., the link to the video is defined by the URI embedded in an NFC tag.

I claim:

1. A Near Field Communications (NFC) opinion expression system adapted to serve an opinion collection content regarding an item to a user and ensure the user is in close proximity to the item, said system comprising:
(a) an NFC device comprises an emitter configured to emit a signal corresponding to a first designator, wherein said first designator corresponds to the item;
(b) a secondary device comprising a second designator corresponding to a location;
(c) a server adapted to store a plurality of location-based opinion collection contents;
(d) a mobile device configured for obtaining said first designator and said second designator; and
(e) an opinion collection content creator comprising a means for retrieving at least one location-based opinion collection content corresponding to said first and second designators from said server, wherein said means for retrieving at least one opinion collection content is selected from the group consisting of retrieving one or more relevant readily available opinion collection contents that match the item at said location, from a specific Universal Resource Identifier (URI) corresponding to said server and creating one or more new location-based opinion collection contents that relate to the item at said location, said one or more new location-based opinion collection contents are configured to be stored in said server such that said first designator indicates only the item and without association to the location, thereby enabling the use of a generically-programmed inexpensive NFC device for the creation of a location-based opinion collection content.

2. The NFC opinion expression system of claim 1, wherein said secondary device is a device selected from the group consisting of an NFC device, a Domain Name Systems (DNS) device and a Global Positioning System (GPS) device.
